(19) United States
(12) Patent Application Publication
(10) Pub. No.: US 2008/0112329 A1
(43) Pub. Date: May 15, 2008

(54) Method and apparatus for warning telephony users of service degradation

(75) Inventors: Simon Byers, Summit, NJ (US); Allan Wilks, Scotch Plains, NJ (US)

Correspondence Address: AT&T CORP., ROOM 2A207, ONE AT&T WAY, BEDMINSTER, NJ, 07921, US

(73) Assignee: ATT Corp.

(21) Appl. No.: 11/595,610

(22) Filed: Nov. 10, 2006

(51) Int. Cl. H04L 12/26; G08B 21/00

(52) U.S. Cl. 370/241; 340/540

(57) ABSTRACT

A method and apparatus for warning a telephony user of a service degradation in a network such as a packet network are disclosed. For example, the present method enables a terminal adaptor to discover a service degradation by performing a connectivity test (e.g., checking for dial tone, pinging the network service provider, etc). The method then enables the terminal adaptor to warn the customer of the detected service degradation via an attached endpoint, e.g., a telephone.

The present invention relates generally to communication networks and, more particularly, to a method for warning telephony users of service degradation for services provided on networks such as the packet networks, e.g., Voice over Internet Protocol (VoIP) and Service over Internet Protocol (SoIP) networks.

### BACKGROUND OF THE INVENTION

The Internet has emerged as a critical communication infrastructure, carrying traffic for a wide range of important applications. Internet services such as VoIP and SoIP services are becoming ubiquitous and more and more businesses and consumers are relying on their Internet connections for both voice and data transport needs. Customers are provided with more flexible options on Internet Protocol (IP) networks as compared to on traditional networks. However, voice services delivered on IP networks are subjected to IP connectivity failures and degradations. For example, a customer may discover a non-working phone line while originating a 911 call resulting in delayed delivery of emergency services. If the service is degraded, then the customer may have to dial several times before realizing the problem and invoking other alternatives.

Therefore, there is a need for a method and apparatus to warn telephony users of service degradation.

### SUMMARY OF THE INVENTION

In one embodiment, the present invention discloses a method and apparatus for warning a telephony user of a service degradation in a network such as a packet network. For example, the present method enables a terminal adaptor to discover a service degradation by performing a connectivity test (e.g., checking for dial tone, pinging the network service provider, etc). The method then enables the terminal adaptor to warn the customer of the detected service degradation via an attached endpoint, e.g., a telephone.

### BRIEF DESCRIPTION OF THE DRAWINGS

The teaching of the present invention can be readily understood by considering the following detailed description in conjunction with the accompanying drawings, in which:

FIG. 1 illustrates an exemplary network related to the present invention;

FIG. 2 illustrates an exemplary network with one embodiment of the invention for warning telephony user of service degradation;

FIG. 3 illustrates a flowchart of the method for warning telephony user of service degradation; and

FIG. 4 illustrates a high-level block diagram of a general-purpose computer suitable for use in performing the functions described herein.

To facilitate understanding, identical reference numerals have been used, where possible, to designate identical elements that are common to the figures.

### DETAILED DESCRIPTION

The present invention broadly discloses a method and apparatus for warning telephony user of service degradation for services delivered on networks such as the packet networks, e.g., Voice over Internet Protocol (VoIP) and Service over Internet Protocol (SoIP) networks. Although the present invention is discussed below in the context of telephony services on VoIP and SoIP networks, the present invention is not so limited. Namely, the present invention can be applied for other networks such as the cellular network and the like.

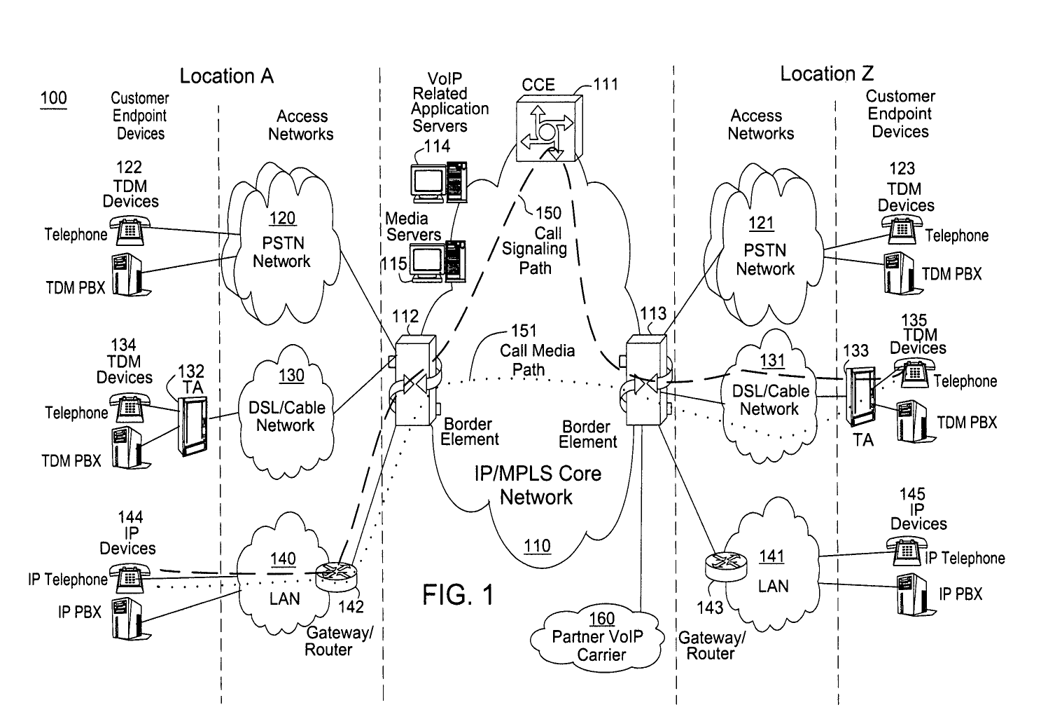

To better understand the present invention, FIG. 1 illustrates an example network 100 related to the present invention. Exemplary packet networks include Internet protocol (IP) networks, Asynchronous Transfer Mode (ATM) networks, frame-relay networks, and the like. An IP network is broadly defined as a network that uses Internet Protocol to exchange data packets. Thus, a VoIP or a SoIP network is considered an IP network.

In one embodiment, the VoIP network may comprise various types of customer endpoint devices connected via various types of access networks to a carrier (a service provider) VoIP core infrastructure over an Internet Protocol/Multi-Protocol Label Switching (IP/MPLS) based core backbone network. Broadly defined, a VoIP network is a network that is capable of carrying voice signals as packetized data over an IP network. The present invention is described below in the context of an illustrative VoIP network. Thus, the present invention should not be interpreted as limited by this particular illustrative architecture.

The customer endpoint devices can be either Time Division Multiplexing (TDM) based or IP based. TDM based customer endpoint devices 122, 123, 134, and 135 typically comprise of TDM phones or Private Branch Exchange (PBX). IP based customer endpoint devices 144 and 145 typically comprise IP phones or IP PBX. The Terminal Adaptors (TA) 132 and 133 are used to provide necessary inter-working functions between TDM customer endpoint devices, such as analog phones, and packet based access network technologies, such as Digital Subscriber Loop (DSL) or Cable broadband access networks. TDM based customer endpoint devices access VoIP services by using either a Public Switched Telephone Network (PSTN) 120, 121 or a broadband access network 130, 131 via a TA 132 or 133. IP based customer endpoint devices access VoIP services by using a Local Area Network (LAN) 140 and 141 with a VoIP gateway or router 142 and 143, respectively.

The access networks can be either TDM or packet based. A TDM PSTN 120 or 121 is used to support TDM customer endpoint devices connected via traditional phone lines. A packet based access network, such as Frame Relay, ATM, Ethernet or IP, is used to support IP based customer endpoint devices via a customer LAN, e.g., 140 with a VoIP gateway and router 142. A packet based access network 130 or 131, such as DSL or Cable, when used together with a TA 132 or 133, is used to support TDM based customer endpoint devices.

The core VoIP infrastructure comprises of several key VoIP components, such as the Border Elements (BEs) 112 and 113, the Call Control Element (CCE) 111, VoIP related Application Servers (AS) 114, and Media Server (MS) 115. The BE resides at the edge of the VoIP core infrastructure and interfaces with customers endpoints over various types of access networks. A BE is typically implemented as a Media Gateway and performs signaling, media control, security, and call admission control and related functions. The CCE resides within the VoIP infrastructure and is connected to the BEs using the Session Initiation Protocol (SIP) over the underlying IP/MPLS based core backbone network 110. The CCE is typically implemented as a Media Gateway Controller or a softswitch and performs network wide call control related functions as well as interacts with the appropriate VoIP service related servers when necessary. The CCE functions as a SIP back-to-back user agent and is a signaling endpoint for all call legs between all BEs and the CCE. The CCE may need to interact with various VoIP related Application Servers (AS) in order to complete a call that requires certain service specific features, e.g. translation of an E.164 voice network address into an IP address and so on.

For calls that originate or terminate in a different carrier, they can be handled through the PSTN 120 and 121 or the Partner IP Carrier 160 interconnections. For originating or terminating TDM calls, they can be handled via existing PSTN interconnections to the other carrier. For originating or terminating VoIP calls, they can be handled via the Partner IP carrier interface 160 to the other carrier.

In order to illustrate how the different components operate to support a VoIP call, the following call scenario is used to illustrate how a VoIP call is set up between two customer endpoints. A customer using IP device 144 at location A places a call to another customer at location Z using TDM device 135. During the call setup, a setup signaling message is sent from IP device 144, through the LAN 140, the VoIP Gateway/Router 142, and the associated packet based access network, to BE 112. BE 112 will then send a setup-signaling message, such as a SIP-INVITE message if SIP is used, to CCE 111. CCE 111 looks at the called party information and queries the necessary VoIP service related application server 114 to obtain the information to complete this call. In one embodiment, the Application Server (AS) functions as a back-to-back user agent. If BE 113 needs to be involved in completing the call, CCE 111 sends another call setup message, such as a SIP-INVITE message if SIP is used, to BE 113. Upon receiving the call setup message, BE 113 forwards the call setup message, via broadband network 131, to TA 133. TA 133 then identifies the appropriate TDM device 135 and rings that device. Once the called party accepts the call at location Z, a call acknowledgement signaling message, such as a SIP 200 OK response message if SIP is used, is sent in the reverse direction back to the CCE 111. After the CCE 111 receives the call acknowledgement message, it will then send a call acknowledgement-signaling message, such as a SIP 200 OK response message if SIP is used, toward the calling party. In addition, the CCE 111 also provides the necessary information of the call to both BE 112 and BE 113 so that the call data exchange can proceed directly between BE 112 and BE 113. The call signaling path 150 and the call media path 151 are illustratively shown in FIG. 1. Note that the call signaling path and the call media path are different; because once a call has been set up between two endpoint devices the CCE 111 does not need to be in the data path for actual direct data exchange.

Media Servers (MS) 115 are special servers that typically handle and terminate media streams, and are used to provide services such as announcements, bridges, trans-coding, and Interactive Voice Response (IVR) messages for VoIP service applications. The media servers also interact with customers for media session management to accomplish tasks such as process requests.

Note that a customer in location A using any endpoint device type with its associated access network type can communicate with another customer in location Z using any endpoint device type with its associated network type as well. For instance, a customer at location A using IP customer endpoint device 144 with packet based access network 140 can call another customer at location Z using TDM endpoint device 123 with PSTN access network 121. The BEs 112 and 113 are responsible for the necessary signaling protocol translation, e.g., SS7 to and from SIP, and media format conversion, such as TDM voice format to and from IP based packet voice format.

The above network is described to provide an illustrative environment in which packets are transported on networks such as VoIP and SoIP networks. Internet services such as VoIP and SoIP services are becoming ubiquitous and more and more customers are relying on their Internet connections for all their transport needs. Internet based services enable the customers to obtain more flexible services as compared to services on traditional networks. Combining all services on the Internet based platform also enables customers to share resources such as routers, broadband connections, etc. among multiple end users.

However, voice services delivered on IP networks are subjected to greater connectivity failures and degradations when compared to non-IP networks. For example, broadband cable networks in general have more outages as compared to traditional telephone lines. One of the main concerns of customers is discovering a non-working phone line while originating a call. Depending on the type of the call, the result might be catastrophic for the user. For example, a customer discovering a non-working phone line while dialing 911 may result in delayed delivery of emergency services. If the service is degraded, then the customer may still attempt to place the call several times before realizing the problem and invoking other alternatives. Therefore, there is a need for a method and apparatus to warn telephony users of service degradations.

The present invention discloses a method and apparatus for warning telephony users of service degradations. In one embodiment, the present invention provides a method for enabling a terminal adaptor to determine connectivity failures or degradations and to alert the customer via an attached endpoint, e.g., a telephone. In order to clearly illustrate the teachings of the present invention, the following terminologies will first be described:

A router;

A cable modem; and

A DSL modem.

A router is a networking device used to forward packets towards their destination using the Layer-3 networking protocol such as IP. In the home or small office environment, it is used to handle the sharing of the Internet connection. Thus, the router has address translation capability to allow multiple computers to access the Internet using a single public IP address. The router in this environment may perform functions associated with a firewall, an Ethernet hub and/or a wireless hub. When analog phones are used to access VoIP services, the router may also include RJ-11 ports for connecting with a TA. Hence, the router has a variety of ports such as Ethernet ports, RJ-11 ports, wireless ports and the like to enable sharing of the network connection and a port for connecting to a broadband access network, e.g., a DSL broadband network or a Cable broadband network.

A cable modem is a device used to access the information contained on the channels transmitted on the coaxial cable. A cable modem contains at least a tuner for selection of frequencies, a demodulator for converting the radio frequency signals to signals that vary with voltage, an analog to digital converter, a Media Access Control (MAC) and a processor. If it is used for Internet access it also contains a digital to analog converter and a modulator. When a home network is connected to the cable network through the router, different channels are used for the CATV and Internet services such as VoIP services. The cable modem separates the channels for the Internet services and the CATV. The packets on the channels for Internet services are forwarded to the router. If only one computer is connected to the Internet, the computer can be directly connected to the cable modem without the router.

A Digital Subscriber Line (DSL) modem is a device with modulation scheme used to connect data devices such as a computer for transporting packets on the telephone network. DSL uses existing phone lines to connect to the Internet.

Thus, the broadband access service can be provided on a DSL or a cable network. The appropriate modem is utilized based on the type of broadband access subscription that has been acquired by the customer. In order to originate a call using an analog device, the analog device is attached to a terminal adaptor that is, in turn, connected to either the router or directly to the broadband modem. The present invention provides a method for enabling the terminal adaptor to determine connectivity failures or degradations and to warn the customer accordingly via an attached endpoint device, e.g., by ringing an attached telephone with a predefined ring pattern.

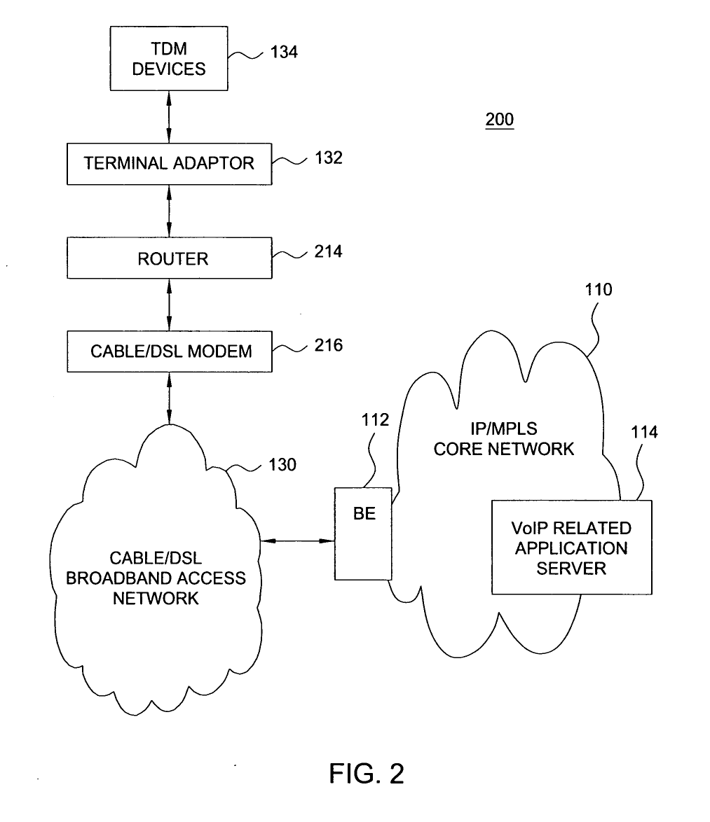

FIG. 2 illustrates an exemplary network 200 with one embodiment of the present invention for warning a telephony user of a service degradation. For example, the customer typically uses a TDM device 134 to originate calls. The TDM device 134 is connected to a terminal adaptor 132 which, in turn, is connected to a broadband cable/DSL modem 216 through a router 214. The broadband modem 216 is connected to a broadband DSL or cable access network 130. The packets transmitted by the TDM device 134 traverse the access network 130 and reach an IP/MPLS core network 110 through a border element 112. The packets then traverse the core network 110 towards their intended destination.

In one embodiment, a VoIP application server 114 located in the IP/MPLS core network 110 is utilized for processing packets originated by the terminal adaptor 132 for assisting the TA in determining the connectivity and degradation of services. For example, application server 114 may terminate test calls from various terminal adaptors to enable the terminal adaptors to discover connectivity to the core network 110. In another example, the TA 132 may send “ping” packets periodically to the application server 114. This approach allows the TA to log responses from the application server 114 over time, thereby allowing the TA to perform qualitative analysis (e.g., determining packet loss statistics, delay, route variations, etc.). Using the results of the analysis, the TA has the ability to provide warning to the customer if degradation of services is detected.

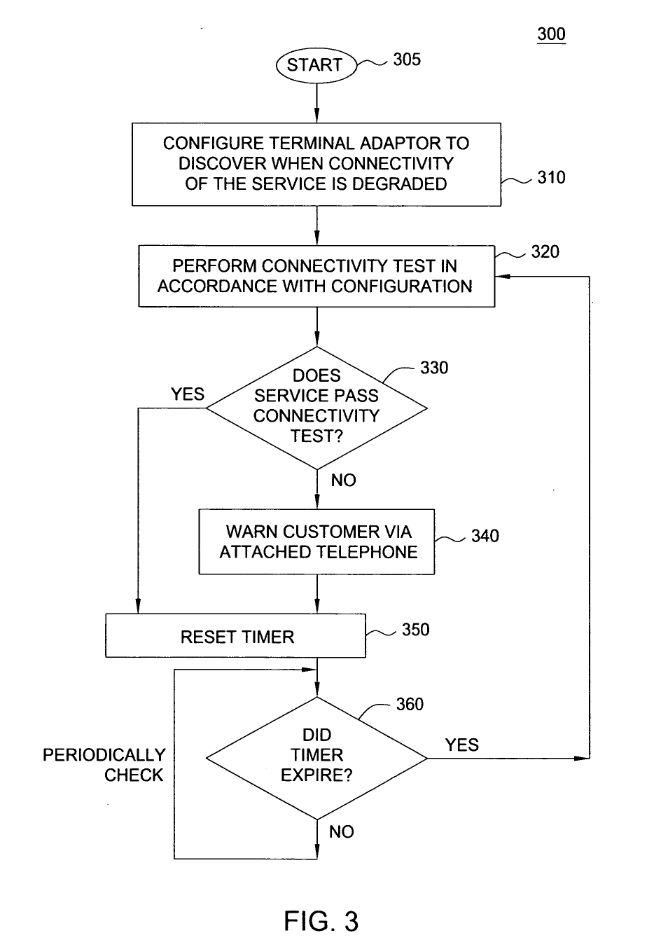

FIG. 3 illustrates a flowchart of the method for warning telephony customers of service degradation. Method 300 starts in step 305 and proceeds to step 310.

In step 310, method 300 configures a terminal adaptor to discover when connectivity of the service is degraded and to warn customer. For example, the TA may be configured to go off-hook from time to time to check whether or not there is a dial tone. In another example, the TA may generate a call to a test telephone number and measures the response time and so on. In one embodiment, various parameters can be configured by a user, e.g., a testing time interval (e.g., every 6 hours, once a day, etc.), a quality level threshold where a warning should be generated (e.g., no dial tone, extremely long delay, pinging calls are being blocked due to congestion, etc.), and so on. It should be noted that a default configuration can be implemented and offered to the user as well to expedite the configuration step.

In step 320, method 300 performs a connectivity test periodically in accordance to the set configuration as defined in step 310. It should be noted that the term “connectivity test” broadly encompasses both a measure of the existence of a connection and/or a measure of a quality of the connection if the connection exists. For example, the TA may go off-hook and check whether or not there is a dial tone every 6 hours. This test, at minimum, ensures that there is connectivity and that an out going call can be made.

Alternatively, the TA may ping the application server 114 to perform a more detailed analysis. In one embodiment, the TA may perform various measurements to determine the quality of the service, e.g., delay characteristics, loss of packets, route changes, etc. For example, the TA may originate one or more test calls to a predetermined phone number to obtain responses to ping messages for the purpose of detecting failures and/or degradations. For example, the application server 114 in the service provider's network may terminate the packets for calls to the pre-determined phone number and sends back the appropriate responses. This implementation enables the TA to discover connectivity issues such as loss of packets. For example, if the TA generates x packets and expects to receive the same number of packets back from the application server, but only receives 50% of the x packets, then the TA may have discovered that the service has not failed completely but there is a degradation of the service. Thus, if the degradation falls below a pre-determined threshold, then a warning to the customer may be warranted. Similarly, if the responses are received with various delays, then the TA may warn the customer if the measured delays exceed a pre-determined threshold. It should be noted that the above tests for connectivity (failure, degradation, quality, etc.) are automatically initiated by the TA. The type of tests to be implemented are determined and configured by the customer and/or the service provider. The above illustrative methods for testing connectivity are not intended to limit the scope of the present invention.

In step 330, method 300 determines whether or not the service passes the connectivity test. For example, a loss of one packet out of 100 packets may be acceptable for a customer, but not having a dial tone is not acceptable. If the service passed the connectivity test, then the method proceeds to step 350. Otherwise, the method proceeds to step 340.

In step 340, method 300 warns the customer via an attached endpoint device, e.g., an attached telephone or an attached PC. For example, the TA may be configured to ring the telephone in accordance with a predefine ring pattern when the connectivity test has failed. The TA may be configured to use different rings (tones, number of rings, etc.) for indicating the detection of failures and/or degradations of the subscribed service. In one embodiment, the TA may also provide various visible signals (e.g., a blinking light on one or more LEDs, a message on a display, and so on) for indicating the detection of failures and/or degradations of the subscribed service. In one embodiment, the TA may perform several tests and may be configured to provide different warning signals, e.g., a red blinking signal indicates no dial tone, whereas a blinking yellow signal indicates a degradation of the service. It should be noted that if a PC is available, the warning signals can be presented to the PC as well. The method then proceeds to step 350.

In step 350, method 300 resets the timer and proceeds to step 360. In step 360, method 300 periodically checks the timer to determine whether the timer has expired. When the timer expires, the method proceeds back to step 320 to perform one or more connectivity tests. In one embodiment, if a degradation has been detected, then method 300 may optionally lower the time interval for performing the testing in step 330. This increase in the frequency of performing the testing will allow the present method to quickly determine if and when the system returns to a normal operating condition.

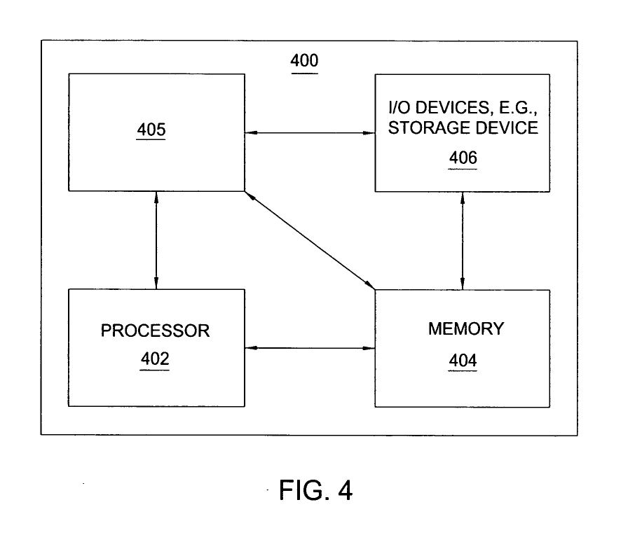

FIG. 4 depicts a high-level block diagram of a general-purpose computer suitable for use in performing the functions described herein. As depicted in FIG. 4, the system 400 comprises a processor element 402 (e.g., a CPU), a memory 404, e.g., random access memory (RAM) and/or read only memory (ROM), a module 405 for warning telephony user of service degradation, and various input/output devices 406 (e.g., storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, alarm interfaces, power relays and the like)).

It should be noted that the present invention can be implemented in software and/or in a combination of software and hardware, e.g., using application specific integrated circuits (ASIC), a general-purpose computer or any other hardware equivalents. In one embodiment, the present module or process 405 for warning telephony user of service degradation can be loaded into memory 404 and executed by processor 402 to implement the functions as discussed above. As such, the present method 405 for warning telephony user of service degradation (including associated data structures) of the present invention can be stored on a computer readable medium or carrier, e.g., RAM memory, magnetic or optical drive or diskette and the like.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method for warning a user of a service degradation of a service in a communication network, comprising:
performing a connectivity test by a terminal adaptor (TA) to determine whether there is a service degradation; and
providing a warning by said terminal adaptor to said user if said service degradation is detected.

2. The method of claim 1, wherein said communication network is a packet network.

3. The method of claim 1, wherein said warning is provided via an endpoint device that is attached to said terminal adaptor.

4. The method of claim 3, wherein said endpoint device is a telephone.

5. The method of claim 1, wherein said warning comprises at least one of: an audible warning, or a visible warning.

6. The method of claim 5, wherein said warning has a predefined pattern.

7. The method of claim 1, wherein said service degradation comprises at least one condition of: a condition of having no dial tone in a connection, or a condition where there is a decreased measure of quality in a connection.

8. The method of claim 1, wherein said performing said connectivity test is performed automatically in accordance with a predefined time interval.

9. The method of claim 1, wherein said performing said connectivity test comprises determining whether there is a dial tone on a connection.

10. The method of claim 1, wherein said performing said connectivity test comprises sending a pinging message to an application server operated by a service provider.

11. A computer-readable medium having stored thereon a plurality of instructions, the plurality of instructions including instructions which, when executed by a processor, cause the processor to perform the steps of a method for warning a user of a service degradation of a service in a communication network, comprising:
performing a connectivity test by a terminal adaptor (TA) to determine whether there is a service degradation; and
providing a warning by said terminal adaptor to said user if said service degradation is detected.

12. The computer-readable medium of claim 11, wherein said warning is provided via an endpoint device that is attached to said terminal adaptor.

13. The computer-readable medium of claim 12, wherein said endpoint device is a telephone.

14. The computer-readable medium of claim 11, wherein said warning comprises at least one of: an audible warning, or a visible warning.

15. The computer-readable medium of claim 14, wherein said warning has a predefined pattern.

16. The computer-readable medium of claim 11, wherein said service degradation comprises at least one condition of: a condition of having no dial tone in a connection, or a condition where there is a decreased measure of quality in a connection.

17. The computer-readable medium of claim 11, wherein said performing said connectivity test is performed automatically in accordance with a predefined time interval.

18. The computer-readable medium of claim 11, wherein said performing said connectivity test comprises determining whether there is a dial tone on a connection.

19. The computer-readable medium of claim 11, wherein said performing said connectivity test comprises sending a pinging message to an application server operated by a service provider.

20. A terminal adaptor (TA) for warning a user of a service degradation of a service in a communication network, comprising:
means for performing a connectivity test to determine whether there is a service degradation; and
means for providing a warning to said user if said service degradation is detected.
